(19) United States
(12) Patent Application Publication
(10) Pub. No.: US 2008/0113872 A1
(43) Pub. Date: May 15, 2008

(54) Classification of Organisms Based on Genome Representing Arrays

(76) Inventors: Frank Henri Johan Schuren, Veenendaal (NL); Martinus Petrus Maria Caspers, Rijswijk (NL); Bianca Johanna Catherina Van der Werff-van der Vat, Ede (NL); Roy Christiaan Montijn, Amsterdam (NL)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/579,025

(22) PCT Filed: Apr. 29, 2005
(86) PCT No.: PCT/NL05/00327

§ 371 Date: Aug. 2, 2007

(30) Foreign Application Priority Data
Apr. 29, 2004 (EP) 04076309.6

(51) Int. Cl. C40B 30/04; C40B 50/06

(52) U.S. Cl. 506/9; 506/26

(57) ABSTRACT

The invention relates to a method of preparing clusters of reference hybridization patterns for a sample nucleic acid, comprising providing an array comprising a plurality of nucleic acid molecules, wherein said plurality of nucleic acid molecules is derived from at least two different sources, providing at least two different reference hybridization patterns by hybridizing said array with at least two different reference nucleic acids, wherein the sources of said at least two different reference nucleic acids are separable into at least two groups on the basis of a value for at least one phenotypic parameter, and clustering the reference hybridization patterns by unsupervised multivariate analysis. The method further provides a method for typing sample nucleic acid, comprising providing at least two different clusters of reference hybridization patterns for a sample nucleic acid by using a method according to the invention, hybridizing the same array as used for preparing the reference hybridization patterns with sample nucleic acid to obtain a sample hybridization pattern, and assigning the sample hybridization pattern to one of said at least two different clusters of reference hybridization patterns.

### TECHNICAL FIELD

The invention relates to the fields of array technology, diagnostics and molecular biology. More in particular, the present invention relates to a method for typing sample nucleic acid employing nucleic acid arrays.

### BACKGROUND OF THE INVENTION

Array technology has become an important tool in various fields related to biology and medicine. Several types of arrays have been developed through the years. With the advent of miniaturization and automation more and more information has been entered into arrays. The current trend in array technology is to generate ever-larger arrays, carrying more and more information on them.

In array-based diagnostics, the hybridization pattern, or the pattern of intensities with which the various spots on the array hybridize to the sample nucleic acid, contains the data which is to be compared to that of another sample nucleic acid. In conventional arrays, the number of nucleotides per spot is preferably kept as low as possible for reasons of economy and precision.

A higher level of information contained on an array is used primarily to provide for more detailed analysis of nucleic acid samples, i.e. to make visible or reveal the minutest differences between two such samples that are to be compared. For instance, in human diagnostics, arrays are used to classify groups of patient having the same disease, but having different prognosis, and thereupon reveal the genes that are responsible for this difference in prognosis. Such experiments are mostly performed on the basis of expression arrays, because only the level of expression of a certain gene is believed to provide for the necessary resolution to distinguish between the two groups of patient, i.e. to provide for sufficient discriminatory power between them.

In these diagnostic methods, known as expression profiling, the nucleic acid used to probe the array—i.e. the expressed mRNA—provides for complex nucleic acid. The introduction of larger numbers of nucleotides in the array now introduces another difficulty, particularly when complex nucleic acid is used to probe the array. In the situation of expression profiling, a large number of spots have signals between the value 0 and 1, indicative for the fact that not all of the nucleic acid in the spot is hybridized to probe nucleic acid, which is a feature used to determine or quantify the level of expression of the genes involved.

Eventually, in comparing the different hybridization patterns, decisions have to be made which signals of the array are included in the analysis and which are left out. Usually this occurs on the basis of cut-off values, introduced to bias the analysis towards inclusion of the most notable or largest changes in intensity of certain spots. A pivotal role in this process plays the reference pattern, the pattern to which the pattern generated with the test material or sample nucleic acid is compared. A problem with the methods of the prior art is now that expression of nucleic acids represents a state the organism is in, which means that the same organism can have different expression patterns depending on the circumstances. The prior art methods are thus less suited to provide for typing of organisms irrespective of their metabolic state.

### SUMMARY OF THE INVENTION

The present invention now aims to overcome this problem by providing a method of preparing reference hybridization patterns for use in comparative array hybridization experiments.

The present inventors have now found a method of preparing reference hybridization patterns that provides for such a high discriminatory power that it allows for a level of typing of sample nucleic acids that is surprisingly detailed. For instance, the present inventors have now found a method of preparing reference hybridization patterns that allows for sample nucleic acids of different bacterial strains to be typed at the level of such detailed phenotypic parameters as resistance to antibiotics, whereas the typing itself occurs on the basis of whole-genome-array differential hybridization. In such whole-genome-array differential hybridization approaches, both the nucleic acid molecules on the array and the sample nucleic acid consist of (random) genomic DNA fragments. That this level of detail is attained is surprising now that one would not expect that distinguishing between antibiotic resistant and sensitive subtypes among bacterial strains would be possible based on the composition of the genomic DNA.

In one aspect the invention provides a method of preparing clusters of reference hybridization patterns for a sample nucleic acid, comprising:

providing an array comprising a plurality of nucleic acid molecules, wherein said plurality of nucleic acid molecules is derived from at least two different sources;

providing at least two different reference hybridization patterns by hybridizing said array with at least two different reference nucleic acids, wherein the sources of said at least two different reference nucleic acids are separable into at least two groups on the basis of a value for at least one phenotypic parameter, and

clustering the reference hybridization patterns by unsupervised multivariate analysis.

Thus, a method of preparing reference hybridization patterns according to the invention uses multiple sources for the array nucleic acids, as well as multiple sources for the reference nucleic acids. These sources may be the same or different. Preferably, reference hybridization patterns are also obtained with nucleic acids derived from the sources for the array nucleic acids, so that various sources may have multiple functions. Thus, at least one of said at least two different sources of said plurality of array nucleic acid molecules is also a source of at least one of said at least two different reference nucleic acids.

In a preferred embodiment, a method of the invention supports whole-genome-array differential hybridization approaches. Thus, preferably the array consists of genomic DNA fragments, preferably of genomic DNA fragments randomly chosen from a mixture of genomic DNA fragments from said least two different sources. Also, the sample nucleic acid preferably consists of genomic DNA, more preferably also genomic DNA fragments.

In a preferred embodiment, the at least two different sources for the plurality of array nucleic acid molecules are (at least suspected to be) (taxonomically) closely related to the source of the sample nucleic acid, i.e. they belong to the same order, preferably the same family, more preferably the same genus, even more preferably the same species, even more preferably the same genetic subspecies.

In another preferred embodiment the average size of the molecules in said array is between about 200 to 5000 nucleotides.

In another preferred embodiment the array comprises between about 1.500 and 5.000 nucleic acid molecules randomly chosen from said at least two different sources.

In another preferred embodiment said plurality of array nucleic acid molecules is derived from natural sources, more preferably of viral, microbial, animal or plant origin, even more preferably a prokaryotic origin.

In another preferred embodiment said at least two different sources for said plurality of array nucleic acid molecules are (taxonomically) closely related.

In another preferred embodiment said plurality of array nucleic acid molecules is derived from at least two different species of prokaryotes.

In another preferred embodiment said plurality of array nucleic acid molecules is derived from at least two different prokaryotic strains that belong to the same genus.

In another preferred embodiment said plurality of array nucleic acid molecules is derived from at least two different prokaryotic strains that belong to the same species.

In another preferred embodiment said plurality of array nucleic acid molecules is derived from a pure culture of a prokaryote.

In another preferred embodiment said plurality of array nucleic acid molecules is derived from eukaryotic DNA.

In another preferred embodiment said plurality of array nucleic acid molecules is derived from at least three, preferably at least 5, and even more preferably at least 8 different sources.

In another preferred embodiment, said method further comprises clustering representations of patterns based on Principal Component Analysis (PCA).

In another aspect, the present invention provides a method for typing sample nucleic acid, comprising:

providing at least two different clusters of reference hybridization patterns for a sample nucleic acid by using a method of preparing clusters of reference hybridization patterns for a sample nucleic acid according to the invention;

hybridizing the same array as used for preparing the reference hybridization patterns with sample nucleic acid to obtain a sample hybridization pattern, and

assigning the sample hybridization pattern to one of said at least two different clusters of reference hybridization patterns.

In one preferred embodiment said sample nucleic acid consists of genomic DNA, more preferably of genomic DNA fragments.

In another preferred embodiment the average size of the fragments in said sample nucleic acid is between about 50 to 5000 nucleotides.

In still another preferred embodiment said method comprises comparing the sample hybridization pattern with clusters of reference hybridization patterns comprising at least 3, more preferably at least 5 and even more preferably at least 50 different reference hybridization patterns.

In still another preferred embodiment said comparison comprises unsupervised multivariate analysis of the reference hybridization patterns together with the sample hybridization pattern, even more preferably further comprising clustering representations of patterns based on Principal Component Analysis (PCA).

In still another preferred embodiment said assigning comprises Partial Least Square-Discriminant Analysis (PLS-DA) of the reference hybridization patterns together with the sample hybridization pattern and wherein at least one phenotypic parameter of which the values are known for the reference hybridization patterns, (and which information is used to supervise the PLS-DA analysis), is additionally determined or estimated for the sample nucleic acid or the source it is derived from.

In still another preferred embodiment, the method further comprises clustering representations of patterns based on the supervised PLS-DA analysis.

In still another preferred embodiment, the method further comprises typing said sample nucleic acid on the basis of the presence or absence in a cluster.

In still another preferred embodiment, said cluster represents patterns sharing a value for a phenotypic parameter of interest.

In still another preferred embodiment, said at least two different sources for the plurality of array nucleic acid molecules are (taxonomically) closely related to the source of the sample nucleic acid.

In still another preferred embodiment, said parameter is antibiotic resistance.

In still another preferred embodiment, said parameter is epidemic character, pathogenicity, virulence, commensalism, heat resistance, pH tolerance, persistence and/or cell death.

In another aspect, the present invention provides a kit of parts, said kit comprising a combination of an array as defined hereinabove, together with at least two different reference hybridization patterns or reference nucleic acids as defined hereinabove.

### BRIEF DESCRIPTION OF THE DRAWINGS

FIG. 1 presents the RiboPrint™ classification of 31 Staphylococcus aureus strains used in the study. All strains are S. aureus hospital isolates except for one reference strain which is from a strain-type collection (TTC 03.151). The figure shows the specific RiboPrint™ pattern of each strain (banding pattern in the middle) and a dendrogram (left) indicating the degree of (Pearson-) correlation between the RiboPrint™ patterns. At the right, for each strain the TTC number (TNO Type Collection, TNO, Zeist, The Netherlands) is given (for details see FIG. 3). Symbols (Δ, □, ♡, , ⋄) at the far right indicate the strain classification according to the PCA-clusters of FIG. 2.

FIG. 2 shows the clustering of S. aureus strains by unsupervised PCA-analysis of whole-genome-array differential hybridization data. Cy-labeled genomic DNA of 31 different S. aureus strains was hybridized to 35 arrays (4 strains in duplo) containing a representation of the S. aureus genome. The quantified fluorescent hybridization patterns of the S. aureus strains, representing a highly complex n-dimensional data-set, were analyzed with Principle Component-Analysis (PCA). The PCA-plot below shows single point projections of each single-strain complex hybridization pattern in a 2-dimensional plane (small circles, with text indicating strain TTC.03 number, for details see FIG. 3). Duplo hybridized strains are indicated with filled small circles and bold text. For reasons of clarity, strains projected close together are manually clustered by ellipses. Each cluster was identified by a symbol (Δ, □, ♡, , ⋄) also indicated at the right of each RiboPrint™ classified strain in FIG. 1. Note: Cy5/Cy3-ratio's were transformed to a 0 and 1 dataset by cut-off 0.5; mean centering was used for scaling.

FIG. 3 shows an overview of S. aureus strains and their resistance characteristics. Resistance to antibiotics was determined by classic agar diffusion-test (columns 2-3: U=Unknown, S=Sensitive, I=intermediate, R=Resistant). Studied S. aureus strains are indicated by TNO Type Collection nr (TTC nr). All strains listed are hospital isolates, except the last entry which is the type strain from a culture collection.

FIG. 4 shows the clustering for resistance to antibiotics of S. aureus strains by supervised PLS-DA analysis of whole-genome-array differential hybridization data. Cy-labeled genomic DNA of 31 different S. aureus strains was hybridized to arrays containing a representation of the S. aureus genome. The quantified fluorescent hybridization patterns of the S. aureus strains, representing a highly complex n-dimensional data-set, were analyzed with Partial-Least-Square-Discriminant-Analysis (PLS-DA) on basis of the known antibiotic sensitivity (S) or resistance (R) of each S. aureus strain. The PLS-DA plots below show single point projections of each single-strains complex hybridization pattern in a 2-dimensional plane (small circles, with text indicating strain TTC.03 number). In duplo hybridized strains are indicated with bold text. Based on a specific part of the dataset, the PLS-DA analysis is able to cluster the strains in two separate clusters (manually placed ellipses, indicated S and R) according to their known antibiotic resistance to 2 different antibiotics (FIG. 4a-b). Note: PLS-DA-scaling was mean centering. FIG. 4a: Clustering of S. aureus gentamycin resistant and sensitive strains based on their genomic composition as analyzed by PLS-DA. FIG. 4b: Clustering of S. aureus oxacillin resistant and sensitive strains based on their genomic composition as analyzed by PLS-DA. Numbers of datasets refer to the strain numbers shown in FIG. 3.

FIG. 5 shows an overview of S. aureus strains and their epidemicity characteristics. Each MRSA strain is identified by a unique TNO Type Collection number (TTC nr, 1^{st} column). Each strain was characterized as S. aureus strains by RiboPrint™ classification (2^{nd} column). Epidemic character was determined from daily hospital practice (3^{rd} column).

FIG. 6 shows the clustering for epidemicity of MRSA strains by supervised PLS-DA analysis of whole-genome-array differential hybridization data. Cy-labeled genomic DNA of 19 different MRSA strains was hybridized to arrays containing a representation of the S. aureus genome. The quantified fluorescent hybridization patterns of the S. aureus strains, representing a highly complex n-dimensional data-set, were analyzed with Partial-Least-Square-Discriminant-Analysis (PLS-DA) on basis of the known epidemic character of each MRSA strain. The PLS-DA plot below shows single point projections of each single-strain complex hybridization pattern in a 2-dimensional plane (small circles, with text indicating strain TTC.03 number mentioned in FIG. 5). In duplo hybridized strains are indicated with bold text. Based on a specific part of the dataset, the PLS-DA analysis is able to cluster the strains in two separate clusters (manually placed ellipses, indicated E=Epidemic and N=non-epidemic) according to their known epidemicity. Note: Cy5/Cy3-ratio's were transformed to a 0 and 1 dataset by cut-off 0.5. PLS-DA-scaling was by mean centering. The non-epidemic strain “236” was positioned in-between the E- and N-cluster by PLS-DA. Numbers of datasets refer to the strain numbers shown in FIG. 5.

FIG. 7 shows an overview of S. aureus strains and their invasiveness characteristics. Each MRSA strain is identified by a unique TNO Type Collection number (TTC nr, 1^{st} column). Each strain was characterized as S. aureus strains by RiboPrint™ classification (2^{nd} column). Epidemic character was determined from daily hospital practice (3^{rd} column).

FIG. 8 shows the clustering for invasiveness of S. aureus strains by supervised PLS-DA analysis of whole-genome-array differential hybridization data. Cy-labeled genomic DNA of 27 different S. aureus strains was hybridized to arrays containing a representation of the S. aureus genome. The quantified fluorescent hybridization patterns of the S. aureus strains, representing a highly complex n-dimensional data-set, were analyzed with Partial-Least-Square-Discriminant-Analysis (PLS-DA) on basis of the known invasive character of each S. aureus strain. The PLS-DA plot below shows single point projections of each single-strain complex hybridization pattern in a 2-dimensional plane. Based on a specific part of the dataset, the PLS-DA analysis is able to cluster the strains in two separate clusters (o non-invasive, +invasive) according to their known invasive character. Numbers of datasets refer to the strain numbers shown in FIG. 7.

FIG. 9 shows an overview of Enterobacter cloacae strains and their infectiousness characteristics (I=Infectious, NI=Non-infectious). Each E. cloacae strain is identified by a unique TNO Type Collection number (TTC nr, 1^{st} column). Each strain was characterized as E. cloacae strains by RiboPrint™ classification (2^{nd} column). Infectiousness character was determined from daily hospital practice (3^{rd} column).

FIG. 10 shows the clustering for infectiousness of E. cloacae strains by supervised PLS-DA analysis of whole-genome-array differential hybridization data. Cy-labeled genomic DNA of 18 different E. cloacae strains was hybridized to arrays containing a representation of the E. cloacae genome. The quantified fluorescent hybridization patterns of the E. cloacae strains, representing a highly complex n-dimensional data-set, were analyzed with Partial-Least-Square-Discriminant-Analysis (PLS-DA) on basis of the known invasive character of each E. cloacae strain. The PLS-DA plot below shows single point projections of each single-strain complex hybridization pattern in a 2-dimensional plane. Based on a specific part of the dataset, the PLS-DA analysis is able to cluster the strains in two separate clusters (o infectious, +non-infectious) according to their known infectious character. Numbers of datasets refer to the strain numbers shown in FIG. 9.

FIG. 11 shows an overview of Legionella pneumophila strains and their pathogenicity characteristics. Each L. pneumophila strain is identified by a unique TNO Type Collection number (TTC nr, 1^{st} column) and an experimental ID (2^{nd} column). Each strain was characterized as L. pneumophila strains by RiboPrint™ classification (3^{rd} column). Pathogenic character was determined from daily hospital practice (4^{th} column).

FIG. 12 shows the clustering for pathogenicity of L. pneumophila strains by supervised PLS-DA analysis of whole-genome-array differential hybridization data. Cy-labeled genomic DNA of 30 different L. pneumophila strains was hybridized to arrays containing a representation of the L. pneumophila genome. The quantified fluorescent hybridization patterns of the L. pneumophila strains, representing a highly complex n-dimensional data-set, were analyzed with Partial-Least-Square-Discriminant-Analysis (PLS-DA) on basis of the known pathogenic character of each L. pneumophila strain. The PLS-DA plots below shows single point projections of each single-strain complex hybridization pattern in a 2-dimensional plane. The upper plot contains experimental names as described in FIG. 11, the lower plot descriptive names. Based on a specific part of the dataset, the PLS-DA analysis is able to cluster the strains in two separate clusters (pat=patient derived, omg=environmental origin) according to their known pathogenic character. Numbers of datasets refer to the strain numbers shown in FIG. 11.

FIG. 13 shows the principle of DA, the goal of which is to find and identify structures in the original data, which show large differences in the group means. This process involves a priori knowledge on which samples have similar characteristics and is therefore said to be a supervised analysis technique. Details on the interpretation of the figure are given herein below.

### DETAILED DESCRIPTION OF THE INVENTION

The present invention follows the trend in array technology to generate ever-larger arrays, carrying more and more information on them. Thereto, arrays of the invention comprise a plurality of nucleic acid molecules, wherein said plurality of nucleic acid molecules is derived from at least two different sources of nucleic acids. The array of the present invention may comprise nucleic acid molecules the characteristics (source, number, length) of which are selected so as to maximize the information obtainable by a single analysis.

Typically, the arrays of the present invention contain at least 500.000 nucleotides on them. Preferably the arrays carry even more nucleotides on them. In a preferred embodiment the array comprises at least 1 megabase (10⁶ nucleotides). Preferably, they comprise at least 2 megabases. Contrary to conventional arrays, the number of bases per spot is high, i.e. between 200 and 5000 nucleotides.

The above described drawback that the use of higher numbers of nucleotides on an array increases the price of the oligonucleotide and simultaneously introduces a larger propensity for errors with respect to the desired sequence, is, at least in part, overcome by the present invention through the preferred use of nucleic acid that is obtained or derived from a natural source, preferably living material.

It is a feature of the present invention that together with (e.g. simultaneously, prior to or after) the genetic comparison between a sample nucleic acid and reference nucleic acid, at least one non-nucleic acid based parameter, herein also called a phenotypic parameter or phenotypic characteristic, such as a morphological feature, a physiological feature, a serological or a pathological feature is determined for each source of reference nucleic acid, which phenotypic parameter is then used in order to enhance the statistical classification of the hybridization patterns and/or to predict the phenotypic parameter belonging to the source of the sample nucleic acid.

In the context of the present invention, a morphological feature is understood to refer to an externally observable feature such as the form of the organism; the possession of a specific biochemical substance, for instance a membrane peptide, a pigment, a (glyco)protein, a lipid or a cell wall component such as mycolic acid; the possession or absence of a specific receptor; the production of spores or cysts; the possession of flagella; growing in chains or in filaments, or another external feature such as a cell or colony morphology; or a coloring characteristic, such as a bacterium's Gram reaction.

In the context of the present invention, a physiological feature is meant to refer to a specific catabolic characteristic such as proteolysis or a capability to grow on specific substrates such as polysaccharides, proteins, fats or nucleic acids; specific nutrient requirements; the possession of specific metabolic routes; a sensitivity to oxygen or a susceptibility to an antibiotic; a temperature or acidity dependence; the production of a specific metabolic final product; the secretion of a bacteriocin or antibiotic; the production of a gas; the manner of energy supply of the organism; the size, composition or another feature of the collection of proteins in the cell (the proteome); or a feature of the collection of low-molecular organic substances in the cell (the metabolome).

In the context of the present invention, a serological feature is meant to refer to the capability to react with a specific antibody or monoclonal; the possession or absence of specific surface antigens or epitopes such as glycolipids or glycoproteins.

In the context of the present invention, a pathological feature is meant to refer to a capability of an organism to infect cells; toxin secretion; a manner in which an infection progresses; the fact whether the organism is epidemic or non-epidemic; a hemolytic characteristic or other pathological feature, such as the natural habitat or the tissue or cell type that is affected by the organism.

The present invention uses differential hybridization to classify sample nucleic acids in general and uses in particular whole-genome differential hybridization to classify and type organisms. The present invention in one embodiment relates to a method employing an array of random genomic DNA fragments from a pool of different strains of bacteria to classify “new” bacteria according to clinically relevant features (such as antibiotic resistance, epidemicity, virulence, pathogenicity, etc.).

Thus, where the present invention prescribes that the sources of at least two different reference nucleic acids must be separable into at least two groups on the basis of a value for at least one phenotypic parameter of interest, a method of the invention will in a preferred embodiment allow for the distinction between resistant and sensitive subtypes, epidemic and non-epidemic subtypes, invasive and non-invasive subtypes, infectious and non-infectious subtypes, and/or environmental and clinical subtypes.

The additional step of providing information on at least one phenotypic feature for the sources of reference nucleic acids provides in one aspect of the invention a method that uses an a-specific collection of e.g. genomic DNA fragments from a group consisting of different organisms to cluster and classify the hybridization pattern obtained with e.g. the gDNA of unknown members within or outside said group, and that is capable of further distinguishing or separating those clusters based on at least one phenotypic feature.

The term a-specific is used deliberately because the array of the present invention provides an analysis tool that is not necessarily suitable only for the analysis of nucleic acids that are related to those spotted on the array, but provides in principle sufficient discriminatory power to allow for the analysis of genomes that are taxonomically removed from or unrelated to the nucleic acids on the array. Yet, the best results and highest discriminatory power is achieved when selecting the nucleic acids for the plurality of nucleic acid molecules of the array as well as the reference nucleic acids for the reference hybridization patterns such that the sample nucleic acid is highly related thereto (i.e. that its hybridization pattern clusters in between or with the reference patterns).

The plurality of nucleic acid molecules on the array is derived from at least two different sources of nucleic acids, preferably the plurality of nucleic acid molecules is derived from at least three, more preferably at least 5, and even more preferably at least 8 different sources. This is to provide for sufficient diversity of the array nucleic acid molecules. There are no other essential requirements to the array nucleic acid molecules.

An array nucleic acid molecule is typically a (usually single stranded) genomic DNA fragment of an organism and a the source of an array nucleic acid is thus typically the genome of an organism.

Another source of nucleic acids is the source of the reference nucleic acids used to generate the reference hybridization patterns. In a method of the present invention, sources of the reference nucleic acids are separable into clusters on the basis phenotypic characteristics or parameters, also termed herein a value for at least one phenotypic parameter of interest. The term “value” includes both quantitative and qualitative values. Thus, for instance, an array comprises genomic DNA fragments from an epidemic bacterial strain as well as genomic DNA fragments from a non-epidemic bacterial strain. It has now inter alia been found that the method of the invention may very suitably be applied for the rapid and accurate typing of microorganisms, in particular bacteria. For instance, in the case of methicillin-resistant staphylococcus aureus (MRSA) it is even possible to distinguish epidemic from non-epidemic strains.

In a particularly preferred aspect of the invention therefore, (reference) nucleic acid obtained or derived from at least two prokaryotic strains is used to generate a reference hybridization pattern. Preferably, at least 5 and more preferably at least 50 reference hybridization patterns are generated by nucleic acid obtained or derived from different prokaryotic strains and may be clustered. In a particularly preferred embodiment essentially all reference hybridization patterns are generated by nucleic acid of prokaryotic strains. Preferably, the different prokaryotic strains belong to the same prokaryotic genus. In this way it is possible to type a sample for the presence therein of nucleic acid derived from a certain prokaryotic genus. More preferably the different prokaryotic strains belong to the same prokaryotic species. In this way it is possible to type a sample for the presence therein of nucleic acid derived from a certain strain of a particular prokaryotic species.

This particularly preferred embodiment is preferably combined with a statistical analysis for comparing the reference and sample hybridization patterns. In this way it is possible to determine the chance that a prokaryote in a sample comprises a certain phenotypic characteristic or genotypic relatedness of some but not all strains of a certain prokaryotic species. The prokaryotic nucleic acid can be derived from RNA but is preferably derived or obtained from prokaryotic DNA. i.e. derived from the genome. Thus in a preferred embodiment of the invention nucleic acid molecules are derived from prokaryotic DNA.

The reference hybridization patterns are typically derived by hybridizing an array of the invention with reference organisms, wherein typically one organism gives rise to one reference hybridization pattern. Preferably, in order to determine the relationship between organisms of the same species, said at least two different reference nucleic acids and sample nucleic acid are derived from different strains of the same species. In one embodiment the present invention relates to a method of classifying genomic DNA of an organism (i.e. the test organism) comprising hybridizing the DNA of said organism to a DNA-array comprising a large number of randomly chosen genomic-DNA fragments, which genomic-DNA fragments are derived from a mixture of at least two, preferably at least 3, more preferably at least 4, still more preferably at least 8 different reference organisms in order to classify the genomic DNA of said a organism amongst said reference organisms.

The term organism as used herein includes microorganisms, plants and animals, including humans. Preferred organisms subjected to a method of the present invention are microorganisms and humans. In the case of plants or animals, the method may very suitably be performed on a sample of a body fluid or tissue of said plant or animal. In the case of microorganisms, the method may very suitably be performed on one or more cells of said microorganism. Microorganisms in the context of the present invention include virus, bacteria, yeast, fungi and parasites, in particular prokaryotes, preferably bacteria, most preferably infectious disease-causing bacteria.

In a preferred embodiment the DNA-array comprises about 1.000 to about 10.000, preferably about 1.500 to about 5.000, most preferably about 1.800 to about 2.400, still more preferably about 1.900 to about 2.200 randomly chosen genomic-DNA fragments.

In a preferred embodiment the randomly chosen genomic-DNA fragments have a length of about 500 to about 5.000, more preferably about 1.000 to about 2.000, more preferably about 1.300 to about 1.800, more preferably about 1.400 to about 1.600 nucleotides. Thus, in a most preferred embodiment, a DNA array employed in a method of the present invention comprises about 3 megabases.

In another embodiment the invention relates to a method of typing a microorganism.

The methods of the invention employ a DNA-array comprising a large number (about 1000 to about 10.000, preferably about 1.500 to about 5.000, most preferably about 1.800 to about 2.400, still more preferably about 1.900 to about 2.200) randomly chosen genomic-DNA fragments (preferably having a length of about 500 to about 5.000, more preferably about 1.000 to about 2.000, more preferably about 1.300 to about 1.800, more preferably about 1.400 to about 1.600 nucleotides), which genomic-DNA fragments are derived from a mixture of at least two, preferably at least 3, more preferably at least 4, for instance 5, 6 or 7, still more preferably at least 8 different micro-organisms in order to classify the genomic DNA of a microorganism. The mixture may suitably represent a gDNA pool of various strains of microorganisms, preferably different strains of one and the same species of a microorganism, preferably bacteria.

The methods of the present invention preferably use whole-genome arrays in order to investigate or determine the presence or absence of comparative (i.e. complementary) DNA regions in other organisms by hybridization. In contrast to the prior art methods, the present invention preferably does not employ so-called open-reading frame (ORF)-probes as nucleic acid molecules on the array. Such probes are derived from and only detect fragments of specific genes, or gDNA fragments of a single organism or a singular group of organisms. Instead, the present invention preferably employs digested genomic DNA to obtain double-stranded gDNA fragments, which fragments are then preferably denatured to serve as single-stranded random gDNA probes that may be combined to form in a plurality of nucleic acid molecules suitable for construction of an array of the invention. In another preferred embodiment of a method of the present invention for typing prokaryotic DNA, a further improvement over the prior art methods is realized by providing an array of random genomic-DNA fragments derived from a gDNA pool of various and different strains. This has the advantage that with a single experiment or assay the relationship can be established between the test organism and a group of reference organisms having a defined taxonomic range and/or having a defined phenotypic characteristic.

The present invention now ultimately allows for the study of multigene features in organisms. The herein described approach thus supports or allows for the incorporation of the classification of phenotypic characteristics of organisms, such as for instance antibiotic resistance of the test-organism regardless of the genetic basis thereof. Thus, when applying the present method to the classification of micro-organisms and including at least one clinically relevant parameter for said micro-organisms (e.g. antibiotic resistance or epidemicity) it is not only the genotypic characteristics that classify the species, but the combined genotypic and phenotypic characteristics of that species, irrespective of any causative relation between the two.

It is not necessary to have detailed knowledge of the sequences that are present on the array. In the present invention patterns are compared with each other.

A suitable method for constructing an array containing a genome-wide representation of at least two different sources (organisms), may start by constructing a mixed-genomic library of at least two organisms by mixing gDNA of said at least two organisms (e.g. bacterial strains of a particular species). Optionally, though not necessarily, organisms are selected that showed each a different value for a phenotypic parameter, e.g. in the case of bacteria, a different profile of resistance to a broad set of antibiotics, preferably together covering most types of antibiotic-resistance. Preferably, the organisms do not contain significant plasmid bands in an agarose-gel analysis of their isolated gDNA. The gDNA mix may then be fragmented (e.g. sheared by sonication) and the fragments are separated for instance in an agarose gel. DNA-fragments of appropriate sizes, preferably about 1-3 kb, may then be isolated (e.g. by excision from the gel and binding to a solid carrier such as glass-milk). A suitable number of gDNA fragments that is randomly retrieved from the gDNA mixture and thus number may range from about 1.000 to about 10.000, preferably about 1.500 to about 5.000, most preferably about 1.800 to about 2.400, still more preferably about 1.900 to about 2.200 randomly chosen genomic-DNA fragments. The effect of the gDNA mixture of multiple organisms is that upon isolation of DNA fragments therefrom, a random pool of fragments from the various organisms is obtained, which is used to construct the array.

The randomly chosen isolated fragments are preferably further multiplied to provide for a proper stock of material. Multiplication of the fragments may for instance be performed by a combination of cloning and nucleic acid amplification techniques as described in Example 1 below. The double stranded gDNA fragments may then be end-modified to allow their immobilization on the array surface, for instance by performing a PCR amplification reaction wherein one or both of the primers contain a free NH2-group coupled via a C6-linker to the 5′ end of the primer.

The randomly chosen, isolated and optionally amplified gDNA fragments may then be spotted on a surface to provide for a DNA micro-array. In order to facilitate coupling of the fragments, the surface of the array (e.g. the slide, the surface of which may i.a. be glass, gold, etc.) may be modified. Spotting may occur by any method available, for instance by using ElectroSpray Ionization (ESI) micro-array printing. After spotting of the fragments, the slide surfaces may be blocked to prevent further attachment of nucleic acids, e.g. by treatment with boro-anhydride in case of formaldehyde modified glass-slide surfaces.

Part of the original gDNA material of the individual organisms is used to provide for material that can be hybridized with the array, i.e. to provide for reference nucleic acid. To facilitate detection of successful hybridization, the gDNA is suitably labelled, preferably fluorescently (e.g. by using Cy™ labels [Amersham Pharmacia Biotech]). Fluorescent labelling kits are commercially available from various manufacturers.

The average size of sample nucleic acid has an effect on the signal distribution on the array. Larger sample molecules comprise more information and are thus more likely to find a suitable hybridization partner in more of the spots. Reducing the average size of the sample nucleic acid can reduce this phenomenon. On the other hand, when the sample nucleic acid is too small the nucleic acid fragments in the sample contain too little genetic information and also find suitable hybridization partners in many spots. The average size of the fragments in the sample nucleic acid is preferably between about 50 and 5000 nucleotides. More preferably, the average size of the fragments in the sample nucleic acid comprises a size of between about 50 and 1000 nucleotides, more preferably between about 50 and 500 nucleotides.

The sample nucleic acid preferably represents the whole sample genome. The hybridization pattern obtained with the sample nucleic acid on the array is compared with a reference hybridization pattern. The reference hybridization pattern can be artificially generated for instance through using knowledge of the nucleic acid composition of a reference sample, for instance the genome sequence of an organism of which the genomic sequence is known. However, in a preferred embodiment, the reference hybridization pattern is generated by hybridizing reference nucleic acid to the array. Comparison of the sample hybridization pattern with the reference can at least be used to determine whether the sample nucleic acid is the same or similar to the reference nucleic acid. This is useful when one needs to determine whether, for instance, the sample nucleic acid contains a particular prokaryote. In this setting a reference hybridization pattern is generated with nucleic acid of the particular prokaryote and when the sample hybridization pattern is essentially the same as the reference hybridization pattern, the sample is identified as containing the particular prokaryote. In a method of the invention the sample hybridization pattern is compared with at least one other reference hybridization pattern. In this way the sample is compared to at least two different reference nucleic acids. Of course, upon continued use of the array, more and more patterns are generated and all of these can be used to compare with the sample nucleic acid. Thus once a pattern is generated with sample nucleic acid this pattern can in a subsequent experiment be used as a reference hybridization pattern. Thus in a preferred embodiment a method of the invention further comprises comparing the hybridization pattern with at least 2 and preferably at least 5 reference hybridization patterns. More preferably at least 10, more preferably at least 100 reference hybridization patterns.

Although arrays of the invention can be used to identify specific sequences in the probe nucleic acid, and thus to type the probe nucleic acid on the basis of a signal in one or a few spots, the full potential of the array lies in the interpretation of all the signals obtained in the spots. This interpretation can be done by a human but is typically done by a computer using statistical software. The sample hybridization pattern and the reference hybridization pattern can be a subset of signals obtained from the array. A pattern can consist of one signal; preferably, the pattern consists of at least 20% of the signals obtained following hybridization to the array. More preferably, the pattern consists of at least 50% of the signals from the array. In a particularly preferred embodiment the pattern comprises at least 80% of the signals of the array.

A method of the invention cannot only be used to determine whether a sample nucleic acid is the same as a particular reference nucleic acid. Particularly, when prokaryotic nucleic acid is used as a sample nucleic acid, the sample hybridization pattern can, as it happens, be different from any of the reference hybridization patterns. A particularly useful characteristic of the methods and arrays of the invention is that also in this case a method of the invention can provide useful information. Phenotypic characteristics associated with the organism from which the sample nucleic acid is derived or obtained are very often the result of the interplay of a large number of different sequences and/or genes. In these situations it is not possible to type a particular sample on the basis of the signal obtained in one or more spots. Rather, the signals of very many different spots need to be compared. The methods and arrays of the invention are particularly suited for this type of analysis. To this end the reference hybridization patterns and the sample hybridization pattern are analyzed using statistical software. In one embodiment, a method of the invention further comprises unsupervised multivariate analysis (PCA) of the reference hybridization patterns together with the pattern generated by the sample nucleic acid. Based on this analysis a pattern is given an n dimensional value (with n representing the total number of datapoints included in the analysis) which can be reduced to its principal components, preferably two, these components can be visualized in a multi-dimensional visualization, preferably in a two-dimensional visualization. The dimensional value of the components can be plotted for all patterns which are included in the analysis whereupon the grouping or clustering of the preferably two-dimensional values of the patterns can be scrutinized. In a preferred embodiment the two-dimensional value of the sample hybridization pattern is compared with all two-dimensional values of the reference hybridization patterns. In this way it is possible to provide a statistical estimation of the relatedness of the organism that the sample nucleic acid is obtained or derived from compared to the included references.

The term “clustering” refers to the activity of collecting, assembling or uniting into a cluster or clusters items with the same or similar characteristics, a “cluster” referring to a group or number of the same or similar items gathered or occurring closely together. “Clustered” indicates that an item has been subjected to clustering. The process of clustering used in a method of the present invention may be done by hand or by eye or by any (mathematical) process known to compare items for similarity in characteristics, attributes, properties, qualities, effects, etc., through data from measurable parameters. Statistical analysis may be used.

It is a feature of the present invention that hybridization patterns are extended with further information on the organism wherefrom a reference and/or sample nucleic acid is obtained or derived. For instance, patterns may be extended with parameters that are determined in a way different from nucleic acid hybridization. For instance, when prokaryotes are the objects of study, it is often important to know the antibiotic resistance phenotype of the prokaryote. This resistance parameter can be added to the statistical analysis. The value of this parameter (resistant or not resistant, or further fine tuning) can be added to the pattern or to the statistical analysis of the patterns. The clustering can subsequently be based on this additional parameter. Thus according to the invention, at least one non nucleic acid based (i.e. phenotypic) parameter is determined for the organisms that were the source of the reference hybridization patterns. The statistical analysis can subsequently be used to determine or estimate the value of this parameter for the organism that was the source of the sample nucleic acid. In a preferred embodiment, a method of the invention further comprises Partial Least Square-Discriminant Analysis (PLS-DA) of the reference hybridization patterns together with the pattern generated by the sample nucleic acid, wherein at least one parameter of which the values are known for the reference hybridization patterns is used to supervise the PLS-DA analysis.

### Partial Least Squares (PLS)

Partial least squares (PLS) has been described extensively in the literature (P. Geladi and B. R. Kowalski, Partial Least Squares Regression: A Tutorial, Analytica Chimica Acta, 185, 1986, 1-17. H. Martens and T. Naes, Multivariate Calibration, John Wiley & Sons, Chichester, 1989.) Whereas a principal component analysis (PCA) model has a descriptive nature, a PLS model has a predictive nature. In PLS, scores*loadings pairs, also called latent variables (LVs), are not calculated to maximise the explained variance in the predicting data set only, but also to maximise the covariance with the data to be predicted. The PLS model can be summarised mathematically by means of Equation (1) and Equation (2).

X=TP^{T}+E (1)

Y=TBQ^{T}+F (2)

Matrix X (also called X-block) represents a n*p matrix of independent variables (n chromatograms, for example, with p retention times per chromatogram), Y (also called Y-block) is a n*q matrix containing the dependent variables (concentrations, for example); P^{T} and Q^{T} are transpose S*p and S*q matrices, containing the dependent and independent variable loadings, respectively; T is an n*S matrix of S latent scores, B is a S*S matrix representing the regression of the scores of the X matrix on the scores of the Y-data; E and F are n*p and n*q matrices containing the residuals of the independent and dependent variables, respectively.

The standard error of validation (SEV) after extracting A LVs, is calculated from Equation (3).

$$SEV = \sqrt{\frac{{\sum }_{I = 1}^{{I}_{c}} {( {Y}_{i , j} - {y}_{i , j} )}^{2}}{{I}_{c}}} \qquad ( 3 )$$

where I_{c} is the number of calibration samples, y_{i,j} is the true value for the concentration of component j in object i; Y_{i,j} is the PLS predicted value for yᵢⱼ; q is the number of Y-variables. The extraction of LVs is continued as long as the SEV is improved significantly.

The number of LVs chosen must yield an optimal prediction of the variable of interest. However, there is a pay-off between variance and bias (or fit): a too complex model fits well, but may predict very poorly. This leads to the concept of optimal model complexity: an optimal balance between fit and variance is obtained, i.e. an increased complexity of the model is generally able to fit more features in the data, but the variance of the estimated parameters rises and the overall result attains a minimum value at the optimal model complexity.

Pure linear relations between X and Y will result in a simple model with usually two to five LVs. Complex non-linear relations can also be modelled. However, these will take up significantly more LVs to correlate Y to X.

### Partial Least Squares—Discriminant Analysis (PLS-DA)

In PLS-DA classes (predefined groups) are used as dependent variables. The Y-block Y is a matrix of n*number of classes. The Y-block is filled with zeros and ones.

For example:

$$class = [ 1221 ] \\ Y = [ \begin{matrix}1 & 0 \\ 0 & 1 \\ 0 & 1 \\ 1 & 0\end{matrix} ] \qquad$$

Using a Y-block in PLS which is filled with zeros and ones dependent on the class each sample belongs to, turns PLS into a discriminant analysis. As alternatives to PLS-DA, any one of the recently developed analysis tools for the classification of datasets may be used such as nearest shrunken centroid (NSC), Support Vector Machines (SVM) or Penalized Logistic regression (PLR) methods.

### Principal Component—Discriminant Analysis (PC-DA)

Discriminant analysis (DA) [D. L. Massart, B. G. M. Vandeginste, L. M. C. Buydens, S. De Jong, P. J. Lewi and J. Smeyers-Verbeke, Handbook of Chemometrics and Qualimetrics: Part A, Elsevier, Amsterdam, 1997; B. G. M. Vandeginste, D. L. Massart, L. M. C. Buydens, S. De Jong, P. J. Lewi and J. Smeyers-Verbeke, Handbook of Chemometrics and Qualimetrics: Part B, Elsevier, Amsterdam, 1998] is applied if the interest is focused on differences between groups of samples. The technique is based on the assumption that samples of the same group are more similar compared to samples of other groups. The goal of DA is to find and identify structures in the original data, which show large differences in the group means. This process involves a priori knowledge of which samples are similar. Therefore, DA is said to be a supervised analysis technique. This distinguishes it from other unsupervised techniques such as principal component analysis (PCA), for example, which does not require a priori knowledge about samples.

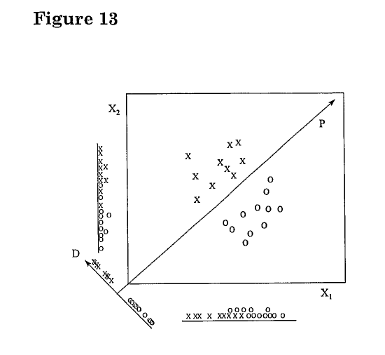

The first step in DA is to combine the original variables into a set of mutually independent new variables in such a way that the projection of the original samples in the space, spanned by a minimum number of these new variables, maximises the difference between the group means. This principle is demonstrated in FIG. 13. Two groups of samples are measured on two variables X₁ and X₂. Using the principal component (PC) maximum variance criterion these samples should be projected on the line through the samples as indicated in FIG. 13 by line P. For discriminating between the different clusters of samples this is not the optimal solution. However, the projection of the samples on line D shows a complete separation between the two clusters. The calculated factors are called discriminants or D-axes. All other projections give sub-optimal solutions. This is demonstrated in the FIG. 13 by comparing the projection of the samples on de D-line with those on the X₁ or X₂ axis.

DA describes most efficiently the differences between groups of samples. However, the number of variables is often large compared to the number of samples. This may lead to degenerate solutions. For instance three samples can always be separated by two variables independent of their similarity. If more samples are included this degeneracy effect will disappear. The general rule of thumb is that the number of samples should be at least four times the number of variables. This rule can lead to problems in the examination of nuclear magnetic resonance (NMR) spectra, for example. In the analysis of natural products the number of peaks (variables) per NMR spectrum is generally in the order of a few hundred. Under normal circumstances this would mean that one should measure at least 400 to 800 samples. In practice this never occurs. Based on this it would be impossible to perform DA on NMR spectra of natural products. However, there is a solution to this problem. Hoogerbrugge et al. [R. Hoogerbrugge, S. J. Willig and P. G. Kistemaker, Discriminant Analysis by Double Stage Principal Component Analysis, Analytical Chemistry, 55, 1983, 1710-1712.] developed a scheme in which the number of variables is reduced by PCA, firstly, followed by DA on the scores of the samples on the first PC axes. This technique is called principal component-discriminant analysis (PC-DA). Determining the exact number of PCs to include is difficult. The number should not be too small because including only the first few can result in a loss of a lot of the between-group information. The number should not be too large also, because it will exceed the number-of-samples-divided-by-four rule. Therefore, it seems advisable to include all PCs, which explain a significant amount of variance (for instance above 1% of the original variance) up to a maximum of the number of samples divided by four. If the total amount of variance explained by these PCs is very low then the number can always be increased. However, if the explained variance is low, the correlations between the original variables will be low also. As a consequence DA will generate a result which will be as complicated as the original problem.

The parameter used in the PLS-DA analysis is preferably a phenotypic parameter. The term “phenotypic parameter” is here used to define any parameter that describes any property that is exhibited or expressed by the organism or a functional part of the organism. Based on this analysis a pattern is given an n-dimensional value (with n representing the total number of discriminating datapoints included in the analysis) which can be reduced to its, preferably two, principal components for optimal correlation with the phenotypic character in a, preferably, two-dimensional visualization. This preferably two-dimensional value can be plotted for all patterns which are included in the analysis whereupon the grouping or clustering of the preferably two-dimensional values of the patterns can be scrutinized. In a preferred embodiment the two-dimensional value of the sample hybridization pattern is compared with all two-dimensional values of the reference hybridization patterns. In this way it is possible to provide a statistical estimation of the chance that the organism that the sample nucleic acid is obtained or derived from comprises a certain phenotypic parameter or not. This of course necessitates that this phenotypic parameter is known for the organisms from which the reference nucleic acids are obtained or derived from. In a preferred embodiment the two-dimensional values of the reference hybridization patterns are clustered based on the supervised PLS-DA analysis.

The clustering is preferably done on the basis of the phenotypic parameter for which the sample hybridization pattern is scrutinized. The clustering preferably results in two clusters, wherein one cluster has the certain phenotype and the other has not, said differently, the sources of two different reference nucleic acids are separable into two clusters on the basis of a value for one phenotypic parameter. The sample hybridization pattern can thus easily be identified as having or not having the certain phenotype. A method of the invention preferably further comprises typing said sample nucleic acid on the basis of the presence or absence in a cluster. This typing is typically associated with a statistical margin of error for the classification, i.e. the statistical chance that the sample nucleic acid is wrongly classified as having or not having the certain phenotypic characteristic. The borders of the clusters can be set to accommodate a smaller or larger statistical chance of error. In a preferred embodiment the parameter comprises antibiotic resistance, epidemic character, pathogenicity, virulence, commensalism, heat resistance, pH tolerance, persistence, cell death and other characteristics of potential interest.

A similar approach can be followed for a wide variety of nucleic acids. As mentioned above, the array is preferably generated from a nucleic acid obtained or derived from a natural source. This source can be of viral, microbial, animal or plant origin. In the case of eukaryotic origin it is preferred that the nucleic acid from the organism is first put through some type of selection system such that repetitive nucleic acid is at least in part removed prior to generating the array. In this way it is prevented that the array contains a lot of redundant information. One way to achieve this is to select sequences that encodes a functional RNA in the eukaryote. This so-called coding nucleic acid typically comprises little if any repetitive nucleic acid. Alternatively, selections are based on other methods. One such other method to enrich for unique sequences is to hybridize nucleic acid from an eukaryotic organism under conditions wherein repetitive nucleic acid is preferably hybridized (making use of Cot curves). Hybridized nucleic acid can be separated from single stranded nucleic acid whereupon the single stranded nucleic acid can be amplified and/or cloned. In a preferred embodiment the source is a simple eukaryote, preferably a single cell eukaryote. These sources contain simpler genomes and accordingly less redundant nucleic acid. In a particularly preferred embodiment, the source is a prokaryote. A prokaryote hardly contains redundant nucleic acid and thus no specific selection step need to be performed for generating an efficient array. In a special embodiment of a prokaryote, a eukaryotic cell organelle containing nucleic acid that is thought to be derived from a prokaryotic ancestor is used as a source of nucleic acid for array construction and/or sample nucleic acid.

An important advantage of a method of the present invention is now that it is not necessary that the organism is first taxonomically classified (e.g. identified) whereupon then the clinically relevant parameter(s) belonging to the identified species can be determined, e.g. as based on a comparison with a list of data on known reference strains. Thus, it is an advantage of the present invention that no species-determination is required in order to determine the presence of, for instance, sensitivity (or resistance) of the test-organism to certain antibiotics, or any other clinically relevant parameter. This is achieved by the fact that such information is now provided “within” the plurality of nucleic acid molecules of the array.

The present method is exceptionally well suited as an aid in medical diagnostic procedures for humans. The method of the present invention for instance allows for the inclusion of inter-individual differences and in particular for the inclusion of clinically relevant parameters such as pre-disposition for cancer and/or depression in such diagnostic procedures.

In methods of the present invention, sample nucleic acid preferably comprises nucleic acid derived from the same organism, genus, species or strain as the organism, genus, species or strain used to generate the reference hybridization patterns. The sample and/or reference nucleic acid used to generate the patterns may contain a subset of nucleic acid of the organism, genus, species or strain it is derived or obtained from. However, preferably, no selections, other than those mentioned for eukaryotic sources are performed. In any case, preferably selections are the same or similar for sample and reference nucleic acid. This allows for an easy comparison of the reference and the sample hybridization patterns.

With the term “nucleic acid obtained or derived from” it is meant that it is not essential that the nucleic acid used to hybridize on the array is directly obtained from the source. It may have undergone cloning, selections and other manipulations prior to the use for hybridizations. Sample and reference nucleic acid can for instance be obtained from cloned libraries, such as expression or genome libraries. Alternatively, sample and reference nucleic acid can be generated from scratch based on the nucleic acid information in databases, for instance, as a result of the ongoing genomics efforts.

However, preferably sample and reference nucleic acid are obtained directly, or through amplification from a natural source. A sample may contain a mixture of organisms, for instance, in the case of a sample obtained from flora containing a plurality of microorganisms. In this case, reference hybridization patterns generated from various microbiological floras can be used to compare the sample hybridization patterns against or with. As mentioned above, a natural source is preferably a prokaryotic source. Preferably, the sample and reference hybridization patterns are generated starting from a monoculture of a prokaryote. In this way it is warranted that only one organism is analyzed on the array, and in the same time the pattern generated is a pattern generated from a prokaryotic strain.

In one preferred embodiment, the invention employs in its various aspects an array comprising a plurality of nucleic acid molecules wherein said nucleic acid molecules comprise an average size of between about 200 to 5000 nucleotides. Preferably, the nucleic acid molecules comprise an average size of between about 200 and 5000 nucleotides. An array of the invention preferably comprises at least 500.000 nucleotides on them. Preferably the arrays carry even more nucleotides on them. In a preferred embodiment the array comprises at least 1 megabases (106 nucleotides). Preferably, they comprise at least 2 megabases. Contrary to conventional arrays, the number of bases per spot is high, i.e. more than 200 nucleotides, preferably the number of bases is between 200 and 5000 nucleotides. Preferably, said plurality of nucleic acid molecules is derived from a natural source. Preferably, said plurality of nucleic acid molecules is derived from prokaryotic DNA. It has been found that different strains of a prokaryote, while belonging to the same species can nevertheless vary greatly in the kind of DNA that they carry.

Thus in a preferred embodiment, an array employed in aspects of the invention comprises a plurality of nucleic acid molecules that is derived from at least two different strains of prokaryotes, preferably of the same species. In this way the array is a more representative of the entire genetic diversity of a prokaryotic species. In a particularly preferred embodiment, the array comprises a plurality of nucleic acid molecules that is derived from at least three different strains of prokaryotes, preferably of the same species. By increasing the number of strains of a prokaryotic species to generate the plurality of nucleic acids in the array, the array more and more mimics the complete genetic potential of a prokaryotic species and thus the typing becomes more and more informative. This does not mean that typing with arrays carrying a reduced number of different prokaryotic strains is not a valid approach; it only means that predictions and estimations become more accurate and complete.

The array itself as described in more detail herein above is contemplated as an aspect of the present invention.

Another aspect of the present invention is a kit of parts, which kit comprises a combination of an array as defined hereinabove together with and at least two different reference hybridization patterns, also as defined hereinabove, which hybridization patterns may for instance be provided in computer-readable format, so as to allow for easy analysis of sample nucleic acids.

The invention will now be illustrated by way of the following, non-limiting examples.

### EXAMPLES

### Example 1

### Clustering of Staphylococcus aureus Strains by Unsupervised PCA-Analysis of Whole-Genome-Array Differential Hybridization Data

Fluorescently labeled genomic DNAs (gDNA) of a set of 31 different Staphylococcus aureus strains were separately hybridized to arrays coated with randomly chosen gDNA fragments of a mixture of 8 different S. aureus strains (approx. 2100 fragments/array, approx. 1500 bp/fragment). The fluorescent hybridization patterns were quantified resulting in a list of hybridizations signals per genomic DNA fragment for each tested strains. To be more specific each array was simultaneously hybridized with 2 labeled gDNAs: one concerning a specific S. aureus strains under investigation (labeled with Cy5), and the other concerning a standard mix of the 8 S. aureus strains used for making of the array serving as a reference to normalize hybridizations made on all the separate slides (labeled with Cy3).

The subsequent data analysis involved filtering, normalization and cut-off-treatment of the data followed by Principal Component Analysis (PCA). This resulted in clustering of similar S. aureus strains based on whole genome differential hybridizations. Reproducibility was shown by duplicate hybridizations for some strains.

### Set of Different Bacterial Strains

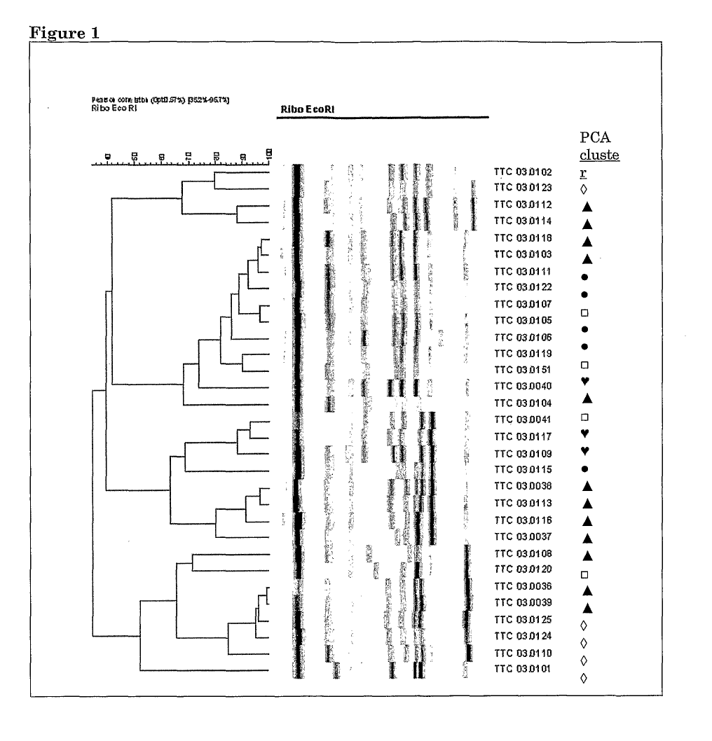

A set of 31 S. aureus strains was used for Example 1 (FIG. 1). The set consisted of 30 hospital isolates and 1 reference strain from a type-strain collection (FIG. 1, strain TTC.03.151). RiboPrint™ (DuPont Qualicon, Wilmington, Del., USA) analysis of part of their ribosomal DNA (DuPont Qualicon, 3531 Silverside Rd, Bedford Building, Wilmington, Del. 19810) indicated various degrees of relation between the different strains of the set (FIG. 1).

### Growth and gDNA Isolation of S. aureus Strains

S. aureus isolates were grown (via single colonies) on TSA-agar plates and/or TSA-medium (overnight, 37° C.) and stored as glycerol cultures (−80° C.). For gDNA isolation, plate grown bacteria (e.g. amount of 10-20 colonies) were resuspended in 400 μl TE-buffer (10 mM Tris-HCl, 1 mM EDTA, pH7.5) in a 2 ml vial. The cells were lysed by adding 400 μl water-washed 0.1 mm Zirconium glass-bead suspension (Biospec Products, Inc., Bartlesville, Okla., USA), precooling on ice, medium-level shaking for 120 sec in a cell disrupter (minibeadbeater 8, Biospec Products, Inc.) and cooling on ice. After centrifugation (5 min, 14 krpm, 4° C.), gDNA was isolated from the cleared lysate according to standard procedures (Sambrook, J., Fritsch, E. F. & Maniatis, T. (1989). Molecular Cloning—A Laboratory Manual, 2nd Edition. Cold Spring Harbour Laboratory Press, New York) by extraction with phenol/chloroform/isoamylalcohol (room temp.), extraction with chloroform/isoamylalcohol (room temp.), precipitation with ethanol/Na-acetate (−20° C., spinning at 4° C.), washing with 70% ethanol (−20° C., spinning at 4° C.), drying (vacuum), dissolving the pellet in 100 μl TE-buffer with RNAseA (1-100 μg/ml) and semi-quantification of the gDNA-amount on 0.6% agarose ethidiumbromide stained gels (e.g. 1-5 μl preparation/slot).

### Construction of S. aureus gDNA Array (Slides)

To make an array containing a genome-wide representation of the species S. aureus, a mixed-genomic library of the organism was made by mixing gDNA of 8 S. aureus strains (for strain selection see FIG. 3). Strains were selected that: (a) showed each a different profile of resistance to a broad set of antibiotics (together covering most types of antibiotic-resistance), and (b) did not contain a significant plasmid band in the agarose-gel analysis of their isolated gDNA. The gDNA mix was sheared by sonication (Branson sonifier 450, Branson, Danbury, Conn., USA) and separated in several lanes of a 0.8% agarose gel. DNA-fragments (approx. 1-3 kb) were excised and isolated via binding to glass-milk (Bio101-kit, Qbiogene, Irvine, Calif., USA). The isolated fragments were pretreatment with DNA-terminator End-repair kit (Lucigen Corp., Middleton, Wis., USA) to facilitate efficient (blunt) cloning into bacterial plasmids (pSmartHCkan vector, CloneSmart Blunt Cloning Kit, Lucigen Corp.). Part of the ligation mix (1 μl) was transformed to 25 μl E. coli cells (E. kloni 10G supreme electrocompetent cells, Lucigen Corp.) by electroporation (0.1 cm-gap cuvets [Eurogentec Ltd., Southampton, United Kingdom] using a BioRad Gene Pulser [BioRad Laboratories, Hercules, Calif., USA] at 25 μF, 200 ohms, 1.6 kV) and regeneration in TB-culture medium and plating on TY-plates with 30 μg/ml kanamycin grown overnight at 37° C. Using tooth-picks, colonies were transferred to into 96-well microtiter plates (32 plates, 150 μl/well TY medium containing 30 μg/ml kanamycin). After overnight growing at 37° C., glycerol was added (final conc. 15%) and the glycerol-stocks were stored at −80° C.

The genomic inserts from each clone in the well-plates were multiplied using PCR-amplification in 96-well PCR-plates (22 plates). PCR reactions contained 50 μl reaction mix/well with 1× SuperTaq buffer, 0.2 mM of each dNTP (Roche Diagnostics GmbH, Mannheim, Germany), 0.4 μM primer L1(5′-cag tcc agt tac gct gga gtc-3′) and 0.4 μM primer R1(5′-ctt tct gct atg gag gtc agg tat g-3′), 1.5 U SuperTaq-DNA-polymerase and 1 μl glycerol stock solution from corresponding well of gDNA-bank. Both primers contain a free NH2-group coupled via a C6-linker to the 5′ end of the primer. The following PCR-program was used: 4 min 94° C., 30× (30 sec 94° C., 30 sec 50° C., 3 min 72° C.), 10 min 72° C. and soaking at 4° C. Following the amplifications, the 50 μl PCR-products were transferred to 96-well round-bottom plates and precipitated by adding 150 μl NaAc/isopropanol mix (0.2M NaAc, 67% isopropanol final conc. each), incubation 1 hr −80° C., spinning (1 hr, 2.5 krpm, 4° C.), removal of supernatant and washing with 100 μl 70% ethanol. DNA-pellets were resuspended in 50 μL water/well, transferred to 384-well plates, dried (speed vac) and resuspended in 10 μl 3×SSC-buffer per well. The 6 resulting 384-well plates, containing approx. 2100 PCR-products were used for spotting the micro-arrays. The PCR-products were spotted on series of maximal 75 “aldehyde” coated slides (Cell Associates, Inc., The Sea Ranch, Calif., USA) using an ElectroSpray Ionization (ESI) micro-array printer in combination with 24 TeleChem Stealth micro spotting quill-pins (approx 100 μm diameter) (TeleChem International, Inc., Sunnyvale, Calif., USA). After spotting, slide surfaces were blocked by treatment at room temperature with boro-anhydride: 2×5 min in 0.2% SDS, 2×5 min in water, 10 min in boro-anhydride buffer (1.7 g NaBH4 in 510 ml PBS-buffer and 170 ml 100% ethanol), 3×5 min in 0.2% SDS, 3×5 min in water, 2 sec in 100° C. water, dry with N₂ flow. PBS (phosphate buffered saline) is 6.75 mM Na2HPO4, 1.5 mM K2HPO4, 140 mM NaCl, and 2.7 mM KCl pH 7.0. (1.2 g Na2HPO4, 0.2 g K2HPO4, 8.0 g NaCl, 0.2 g KCl per liter, pH 7.0).

### Labeling of gDNA

Fluorescent labeling of gDNA was performed on 0.5-2 μg of isolated S. aureus gDNA for 1.5 hr at 37° C. in a 25 μl reaction based on BioPrime® DNA Labeling System (Invitrogen, Carlsbad, Calif., USA; Cat. No.: 18094-011). The reaction contained (final conc): 1× RandomPrimer solution (50 mM Tris-HCl PH 6.8, 5 mM MgCl2, 30 μg/ml random octamers, Bioprime®), 1× lowT dNTP-mixture (0.25 mM dATP, 0.25 mM dGTP, 0.25 mM dCTP, 0.1 mM dTTP), 0.06 mM Cy-dUTP (Cy=either Cy5 or Cy3, 1 μl of 1 mM stock, Amersham Biosciences) and 20 Units DNA-polymerase (Klenow fragment; 0.5 μl of 40 U/μl stock, Bioprime®). After the reaction, salts, unincorporated (labeled) nucleotides and primers were removed by purification over an Autoseq G50 column (Amersham Biosciences). After purification 1/10^{th} part of the labeled material was used for spectrophotometric analysis to determine quantity of DNA (A^{260nm}) and Cy5 (A^{649nm}) or Cy5 (A^{550nm}). The remainder of the labeled material was used for array hybridization.

### (Pre-)Hybridization of Arrays

In preparation for hybridization, slides were laid in Petri dishes, in 20 ml prehybridization solution (1% BSA, 5×SSC, 0.1% SDS, filtered through a 0.45 μm filter, 42° C.) and were gently shaken (by mild rotation) for 45 min at 42° C. Next the slide was washed 2× in 40 ml water (in a 40 ml capped tube) and quickly dried using an N₂-gun.

The appropriate gDNA samples that were labeled with Cy5-dUTP and Cy3-dUTP were combined with 4 μl yeast tRNA (25 μg/μl), dried (using a SpeedVac®, TeleChem International, Inc.), re-dissolved in 40 μl EasyHyb solution (Roche Applied Science, Roche Diagnostics Nederland B.V., Almere, The Netherlands), denatured (1.5 min, 95° C.), spun down briefly (1 sec, 10 krpm), pipetted on a pre-warmed (42° C. metal plate) dry prehybridized array, covered with a plastic cover slip (Hybrislip, Molecular Probes), inserted in a water-vapour-saturated preheated (42° C.) hybridization chamber (Corning Life Sciences B.V., Schiphol-Rijk, The Netherlands) and hybridized overnight in a 42° C. water bath. For each hybridization gDNA from the tester strain was labeled with Cy5-dUTP, whereas a reference pool (mix of gDNAs from the strains which were used for array construction) was labeled with Cy3-dUTP. After hybridization the arrays were washed by shaking slides 4× in 40 ml of (different) buffers in capped 40 ml tubes (wash-buffer1: 1×SSC, 0.2% SDS, 37° C., 5-10 sec; wash-buffer2: 0.5×SSC, 37° C., 5-10 sec; wash-buffer3 and 4: 0.2×SSC, 20° C., each 10 min).

### Scanning and Image Analysis

After washing, slides were stored in the dark (to prevent decay of Cy-fluorescence) or directly used for scanning the fluorescent Cy dyes with a scanning device (ScanArray 4000 from PerkinElmer (PerkinElmer, Wellesley, Mass., USA) with ScanAlyze software (Michael Eisen's lab, University of California at Berkeley (UCB), distributed by Packard Bioscience, PerkinElmer Life And Analytical Sciences, Inc., Boston, Mass., USA). A quickscan (resolution 30 μm/pixel) was performed to select optimal laser-(intensity) and detection (photomultiplier) settings in order to prevent excess of low signals or saturated signals. Slides were 2 times scanned: for Cy5- and Cy3-fluorescence. Digital scans were quantified with ImaGene software (version 4.2, BioDiscovery, Inc. El Segundo, Calif., USA) resulting in a spot identity, and Signal (S) and Background (B) values for both Cy5 and Cy3, for each spot on the array. The data were stored in electronic files and used for further data processing.

### Data Pre-Processing

By using spreadsheet software (Excel, Microsoft) the following calculations were made for each spot: S-B values for Cy3 and Cy5, Cy5/Cy3 ratio's [R=Cy5(S-B)]/[(Cy3(S-B)]. Low quality data were removed (e.g. spots having Cy3 data with S<2B). Then, a normalization factor N was calculated for each slide, based on average Cy5- and Cy3-signal for all spots on a slide (N=[averageCy5(S-B)]/[averageCy3(S-B)]. Next, normalized ratio's (Rₙ) were calculated for each spot (Rₙ=R/N) on all arrays. A matrix (=dataset) of normalized ratio's per spot for many slides (slides relate with S. aureus strains) was used for further data pre-processing.

Since the Cy3 signal is generally present for most spots (Cy3-labeled reference gDNA pool of 8 strains was hybridized to all slides), and the Cy5 signal can vary (Cy5-labeled gDNA of different strains were each hybridized to single slides), the Cy5/Cy3 ratio can in theory have two values (1 or 0) if a gDNA fragment is present or absent respectively, in the Cy5 tested strain. In practice, however, these values vary around 1 and 0. Therefore, in many analyses cut-off values for 0 and 1 were applied on the ratio-dataset before further analysis (e.g. Rₙ<0.5 and Rₙ>0.5 were replaced by 0 and 1 respectively, or, Rₙ<0.3 and Rₙ>0.7 were replaced by 0 and 1 respectively while keeping Rₙ values between 0.3 and 0.5). These “cut-off datasets” were used for the final data analysis.

### PCA Data Analysis

Datasets were analyzed by Principle Component Analysis (PCA) with Mean-Centering as the selected scaling method. Comparable results can be obtained with no or alternative scaling methods (e.g. autoscaling) or alternative multivariate statistics methods.

### Results

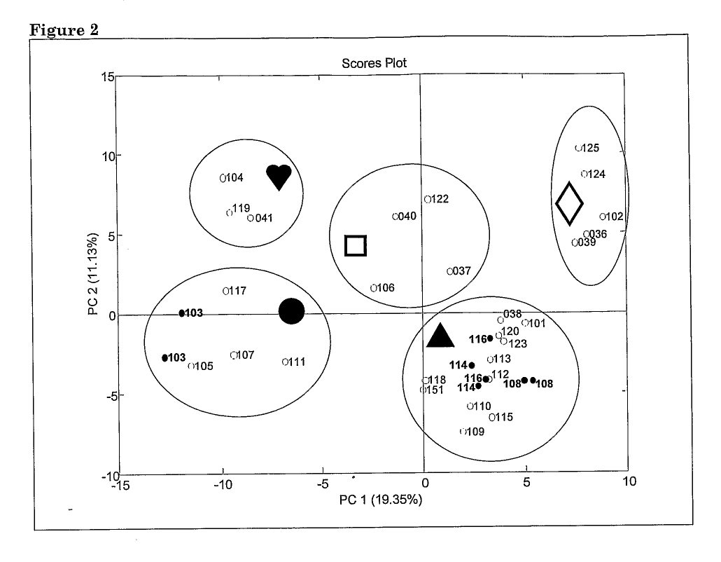

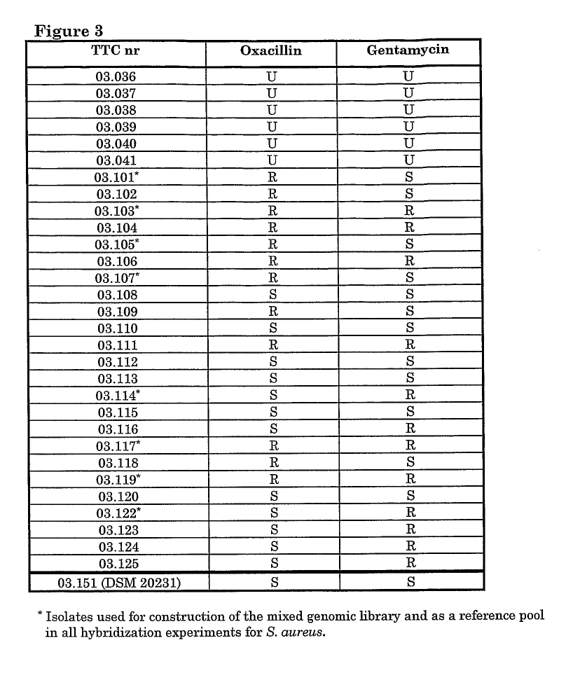

A set of 31 S. aureus strains was processed for the established RiboPrint™ classification method (FIG. 1) and for the classification method of the present invention based on PCA analysis of data from differential hybridization on whole-genome micro-arrays (FIG. 2). Comparison of FIGS. 1 and 2 shows that the method of the present invention (FIG. 2) results in a significantly different strain clustering than the prior art methods (i.e. the RiboPrint™ method of FIG. 1). Because the array/PCA-method (FIG. 2) is based on whole-genome differential hybridization it has a higher potential for classification of closely related organisms than classical classification methods based only on specific DNA sequences (e.g. ribosomal DNA sequence polymorphisms, FIG. 1) or based only on limited phenotypic information (e.g. growth conditions, bacteria staining etc.).

### Example 2

### Clustering Based on Resistance to Specific Antibiotics of S. aureus Strains by Supervised PLS-DA Analysis of Whole-Genome-Array Differential Hybridization Data

Fluorescently labeled genomic DNAs (gDNA) of a set of 31 different S. aureus strains with known resistance/sensitivity to 2 different antibiotics were separately hybridized to arrays coated with randomly chosen genomic DNA fragments of a mixture of 8 different S. aureus strains (approx. 2100 fragments/array, approx. 1500 bp/fragment). The fluorescent hybridization patterns were quantified resulting in a list of hybridizations signals per genomic DNA fragment for each tested strains. To be more specific each array was simultaneously hybridized with 2 labeled gDNAs: one concerning a specific S. aureus strains under investigation (labeled with Cy5), and the other concerning a standard mix of the 8 S. aureus strains used for array construction serving as a reference to normalize hybridizations made on all the separate slides (labeled with Cy3).

The subsequent data analysis involved filtering, normalization and cut-off-treatment of the data followed by Principal Least Square Discriminant Analysis (PLS-DA) on basis of the known sensitivity/resistance of the strains to 2 antibiotics (1 antibiotic per analysis). The 2 independent PLS-DA analyses of the same dataset (only slightly differing in the amount of analyzed strains: only strains for which the resistance profile was clear cut were selected for further analysis) resulted in 2 significant separations within the set of S. aureus strains according to their known sensitivity/resistance against each of the 2 antibiotics. For each antibiotic the sensitive and resistant cluster contained a different subset of strains according to their known antibiotic resistance/sensitivity. This indicates that for each antibiotic, a different part of the total differential hybridization dataset contains antibiotic resistance specific information.

### Set of Different Bacterial Strains

A set of 31 S. aureus strains was used for Example 2 (FIG. 3). The set consisted of 30 hospital isolates and 1 reference strain from a type-strain collection (FIG. 3, strain TTC.03.151). For almost all strains their antibiotic resistance/sensitivity was determined by agar-diffusion test (according to NCCLS protocol) for 2 different antibiotics (gentamycin and oxacillin). All experimental procedures were performed as described in Example 1.

### PLS-DA Data Analysis

Datasets were analyzed by Principal Least Square Discriminant Analysis (PLS-DA) on basis of the known sensitivity/resistance of the strains to a single antibiotic. Comparable results can be obtained with no or alternative scaling methods (e.g. autoscaling) or alternative multivariate statistical methods.

### Results

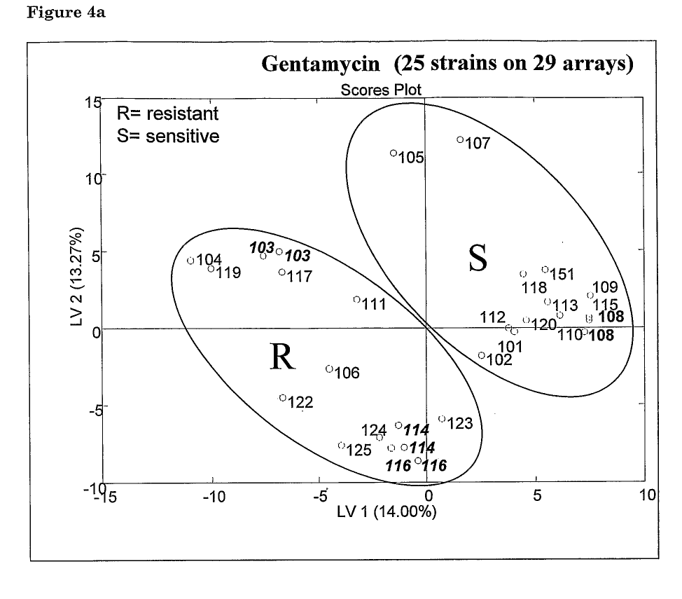

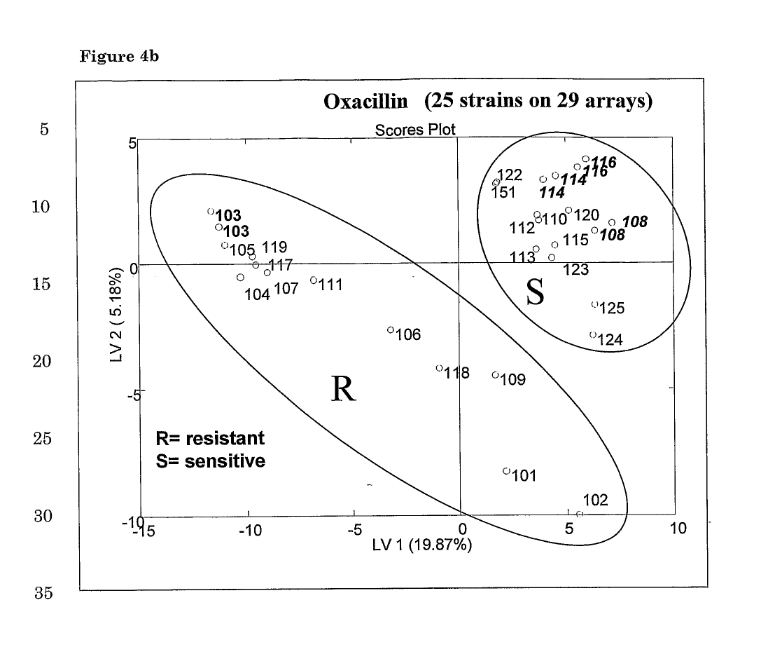

A set of 31 different S. aureus isolates was processed for PLS-DA analysis of data from differential hybridization on whole-genome micro-arrays (FIG. 4).

The 2 independent PLS-DA analyses of the same dataset (only slightly differing in the amount of analyzed strains) resulted in 2 significant separations within the set of S. aureus strains according to their known sensitivity/resistance against each of the 2 antibiotics. For each antibiotic the sensitive and resistant cluster contains a different subset of strains according antibiotic, a different part of the total differential hybridization dataset contains antibiotic specific information. The antibiotic-specific whole-genome hybridization data can be used to predict the antibiotic resistance/sensitivity of unknown S. aureus strains.

### Example 3

### Clustering Based on a Distinction Between Epidemic and Non-Epidemic Staphylococcus aureus Strains by Supervised PLS-DA Analysis of Whole-Genome-Array Differential Hybridization Data

### Set of Different Bacterial Strains

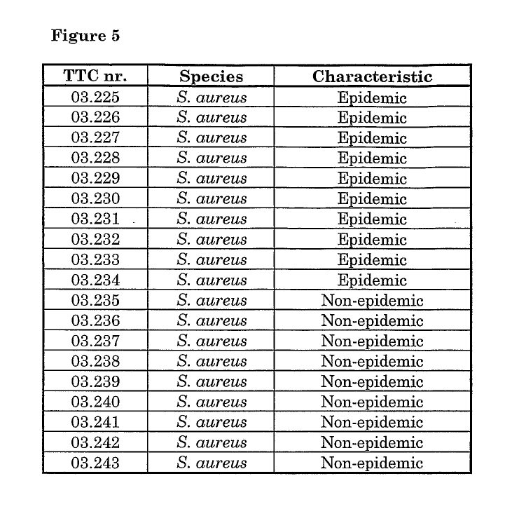

A set of 19 multiple resistant S. aureus strains was used for Example 3 (FIG. 5). The set consisted of 19 hospital isolates. For all strains their epidemic character was abstracted from daily hospital practice (FIG. 5). All experimental procedures used for the generation of micro-array results for these strains were according to the description in example 1.

### Results

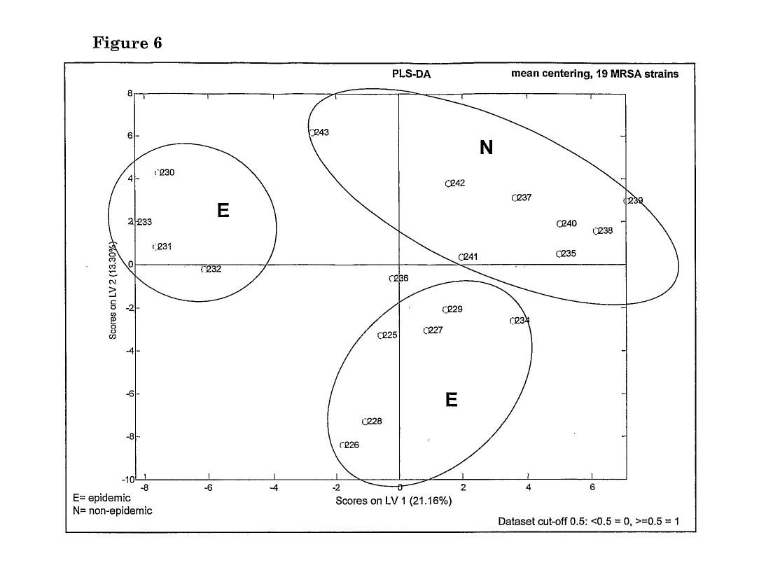

A set of 19 different S. aureus isolates was processed for PLS-DA analysis of data from differential hybridization on whole-genome micro-arrays (FIG. 6).

The PLS-DA analyses resulted in significant clustering of the S. aureus strains according to their known epidemic character (FIG. 6, E=Epidemic, N=Non-epidemic).

This shows that part of the total differential hybridization dataset contains predictive information that can be used to predict epidemicity of unknown S. aureus strains.

### Example 4

### Clustering Based on a Distinction Between Invasive and Non-Invasive S. aureus Strains by Supervised PLS-DA Analysis of Whole-Genome-Array Differential Hybridization Data

### Set of Different Bacterial Strains

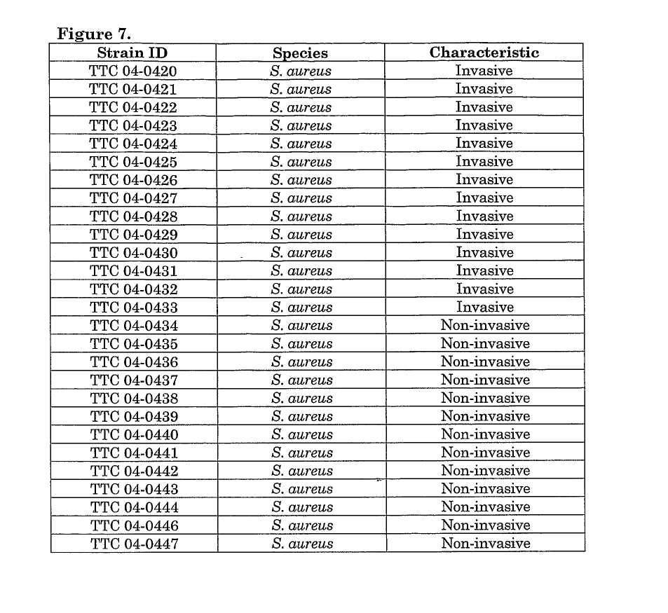

A set of 27 S. aureus strains isolated in hospitals was used for Example 4 (FIG. 7). For all strains their invasive character was abstracted from daily hospital practice (FIG. 7). All experimental procedures used for the generation of micro-array results for these strains were according to the description in example 1 except for the following: ImaGene version 5.6 was used for analyzing the scanned images and data-preprocessing was according to Kim et al. (Genome Biology 3: research0065.1-research0065.17, Epub, Oct. 29, 2002). Their EPP method was used to decide on 0% and 100% EPP (expected probability of presence) values and data points were divided in 3 groups: data below 0% EPP were given the value −0.5, data above 100% EPP were given the value 0.5 and data between 0% and 100% EPP were linearly scaled between −0.5 and 0.5. This preprocessing was performed for each individual dataset (array). The transformed data were used for further analysis.

### Results

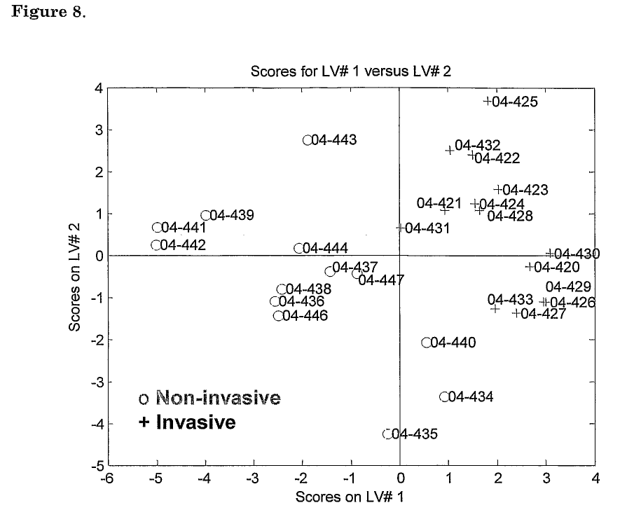

A set of 27 different S. aureus isolates was processed for PLS-DA analysis of data from differential hybridization on whole-genome micro-arrays (FIG. 8).

The PLS-DA analyses resulted in significant clustering of the S. aureus strains according to their known invasive character (FIG. 8, I=invasive, NI=non-invasive).

This shows that part of the total differential hybridization dataset contains predictive information that can be used to predict invasive potential of unknown S. aureus strains.

### Example 5

### Clustering Based on a Distinction Between Infectious and Non-Infectious Enterobacter cloacae Strains by Supervised PLS-DA Analysis of Whole-Genome-Array Differential Hybridization Data

### Experimental Details

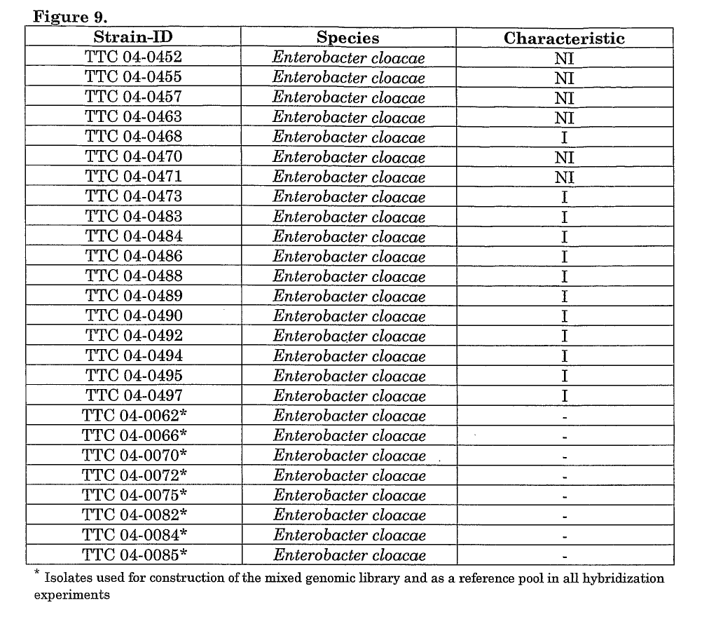

All experimental procedures used for the generation of micro-array results for these strains were according to the description in example 1 except for the following: 8 E. cloacae strains as indicated in FIG. 9 were used for array construction and 3000 spots were put on the arrays. ImaGene version 5.6 was used for analyzing the scanned images and data-preprocessing was according to Kim et al. (Genome Biology 3: research0065.1-research0065.17, 2002). Their EPP method was used to decide on 0% and 100% EPP (expected probability of presence) values and data points were divided in 3 groups: data below 0% EPP were given the value −0.5, data above 100% EPP were given the value 0.5 and data between 0% and 100% EPP were linearly scaled between −0.5 and 0.5. This preprocessing was performed for each individual dataset (array). The transformed data were used for further analysis.

### Set of Different Bacterial Strains

A set of 18 E. cloacae strains isolated in hospitals was used for Example 5 (FIG. 9). For all strains their invasive character was abstracted from daily hospital practice (FIG. 9).

### Results

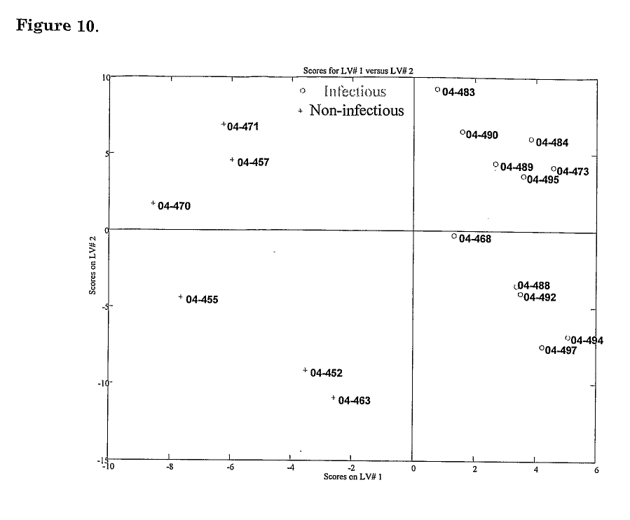

### A set of 18 E. cloacae isolates was processed for PLS-DA analysis of data from differential hybridization on whole-genome micro-arrays (FIG. 10).

The PLS-DA analyses resulted in significant clustering of the E. cloacae strains according to their known infectious character (FIG. 10, I=infectious, NI=non-infectious).

This shows that part of the total differential hybridization dataset contains predictive information that can be used to predict infectious potential of unknown E. cloacae strains.

### Example 6

### Clustering Based on a Distinction Between Environmental and Patient Legionella pneumophila Strains by Supervised PLS-DA Analysis of Whole-Genome-Array Differential Hybridization Data

### Experimental Details

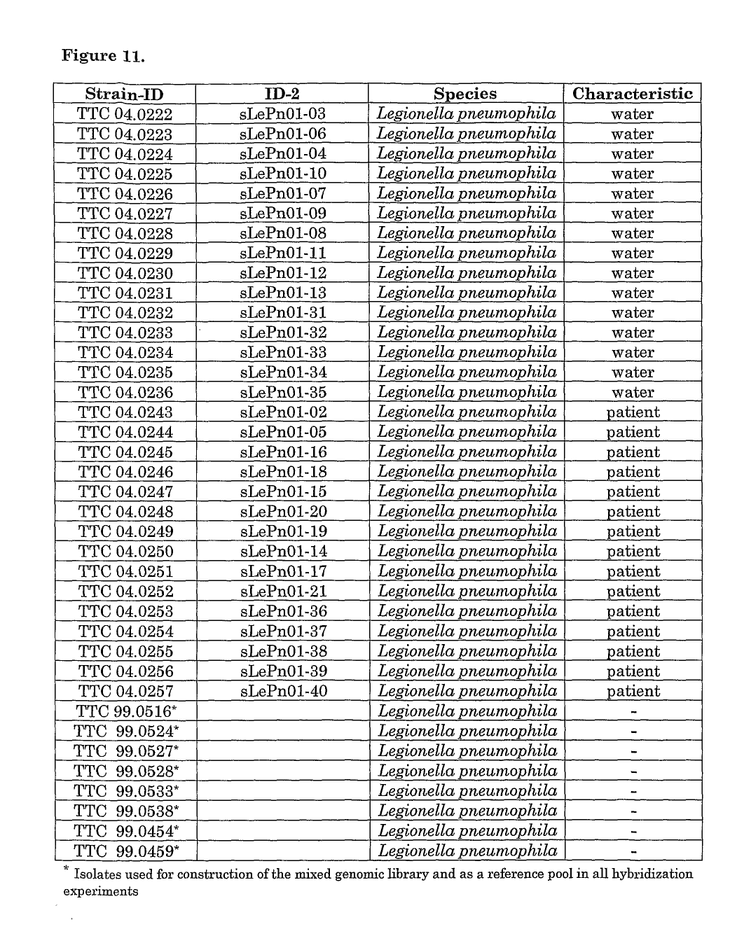

All experimental procedures used for the generation of micro-array results for these strains were according to the description in example 1 except for the following: 8 L. pneumophila strains as indicated in FIG. 11 were used for array construction and 4000 spots were put on the arrays. ImaGene version 5.6 was used for analyzing the scanned images and data-preprocessing was according to Kim et al (Genome Biology 3: research0065.1-research0065.17, 2002). Their EPP method was used to decide on 0% and 100% EPP (expected probability of presence) values and data points were divided in 3 groups: data below 0% EPP were given the value −0.5, data above 100% EPP were given the value 0.5 and data between 0% and 100% EPP were linearly scaled between −0.5 and 0.5. This preprocessing was performed for each individual dataset (array). The transformed data were used for further analysis.

### Set of Different Bacterial Strains

A set of 30 L. pneumophila strains isolated from patients and environmental locations (mainly water sources) was used for Example 6 (FIG. 11). For all patient strains their pathogenic character was abstracted from daily hospital practice (FIG. 11).

### Results

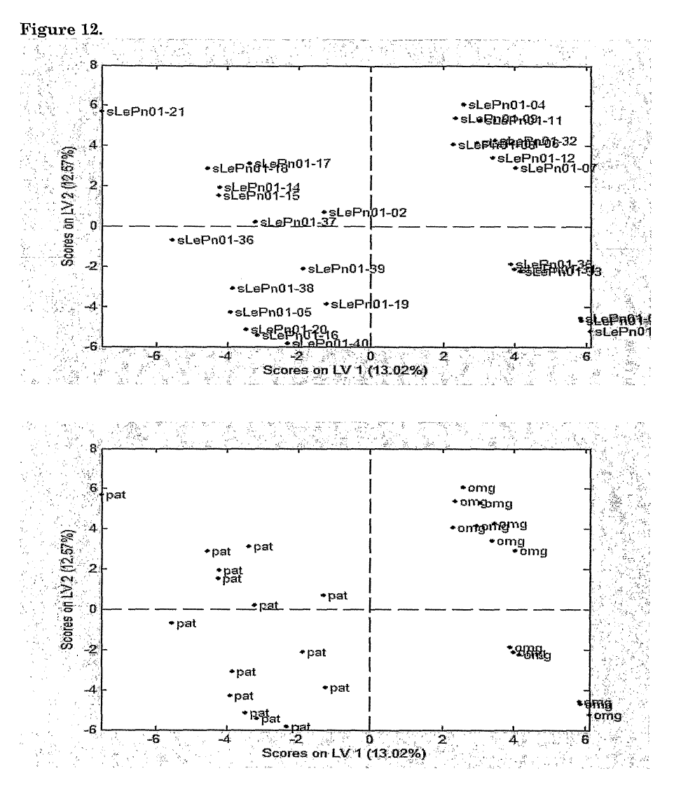

A set of 30 L. pneumophila isolates was processed for PLS-DA analysis of data from differential hybridization on whole-genome micro-arrays (FIG. 12).

The PLS-DA analyses resulted in significant clustering of the L. pneumophila strains according to their known pathogenic character (FIG. 12, pat=patient, omg=environment).

This shows that part of the total differential hybridization dataset contains predictive information that can be used to predict pathogenic potential of unknown L. pneumophila strains.

1. A method of preparing clusters of reference hybridization patterns for a sample nucleic acid, comprising:
providing an array comprising a plurality of nucleic acid molecules, wherein said plurality of nucleic acid molecules is derived from at least two different sources;
providing at least two different reference hybridization patterns by hybridizing said array with at least two different reference nucleic acids, wherein the sources of said at least two different reference nucleic acids are separable into at least two groups on the basis of a value for at least one phenotypic parameter, and
clustering the reference hybridization patterns by unsupervised multivariate analysis.

2. Method according to claim 1, wherein said array consists of genomic DNA fragments, preferably of genomic DNA fragments randomly chosen from a mixture of genomic DNA fragments from said least two different sources.

3. Method according to claim 1, wherein at least one of said at least two different sources of said plurality of array nucleic acid molecules is also a source of at least one of said at least two different reference nucleic acids.

4. Method according to claim 1, wherein the average size of the molecules in said array is between about 200 to 5000 nucleotides.

5. Method according to claim 1, wherein the array comprises between about 1.500 and 5.000 nucleic acid molecules randomly chosen from said at least two different sources.

6. Method according to claim 1, wherein said plurality of array nucleic acid molecules is derived from natural sources, more preferably of viral, microbial, animal or plant origin, even more preferably a prokaryotic origin.

7. Method according to claim 1, wherein said at least two different sources for said plurality of array nucleic acid molecules are (taxonomically) closely related.

8. Method according to claim 1, wherein said plurality of array nucleic acid molecules is derived from at least two different species of prokaryotes.

9. Method according to claim 1, wherein said plurality of array nucleic acid molecules is derived from at least two different prokaryotic strains that belong to the same genus.

10. Method according to claim 1, wherein said plurality of array nucleic acid molecules is derived from at least two different prokaryotic strains that belong to the same species.

11. Method according to claim 1, wherein said plurality of array nucleic acid molecules is derived from a pure culture of a prokaryote.

12. Method according to claim 1, wherein said plurality of array nucleic acid molecules is derived from eukaryotic DNA.

13. Method according to claim 1, wherein said plurality of array nucleic acid molecules is derived from at least three, preferably at least 5, and even more preferably at least 8 different sources.

14. Method according to claim 1, further comprising clustering representations of patterns based on Principal Component Analysis (PCA).

15. A method for typing sample nucleic acid, comprising:
providing at least two different clusters of reference hybridization patterns for a sample nucleic acid by using a method according to claim 1;
hybridizing the same array as used for preparing the reference hybridization patterns with sample nucleic acid to obtain a sample hybridization pattern, and
assigning the sample hybridization pattern to one of said at least two different clusters of reference hybridization patterns.

16. Method according to claim 15, wherein said sample nucleic acid consists of genomic DNA, more preferably of genomic DNA fragments.

17. Method according to claim 15, wherein the average size of the fragments in said sample nucleic acid is between about 50 to 5000 nucleotides.

18. Method according to claim 15, wherein said method comprises comparing the sample hybridization pattern with clusters of reference hybridization patterns comprising at least 3, more preferably at least 5 and even more preferably at least 50 different reference hybridization patterns.

19. Method according to claim 18, wherein said comparison comprises unsupervised multivariate analysis of the reference hybridization patterns together with the sample hybridization pattern.

20. Method according to claim 19, further comprising clustering representations of patterns based on Principal Component Analysis (PCA).

21. Method according to claim 15, wherein said assigning comprises Partial Least Square-Discriminant Analysis (PLS-DA) of the reference hybridization patterns together with the sample hybridization pattern and wherein at least one phenotypic parameter of which the values are known for the reference hybridization patterns, (and which information is used to supervise the PLS-DA analysis), is additionally determined or estimated for the sample nucleic acid or the source it is derived from.

22. A method according to claim 21, further comprising clustering representations of patterns based on the supervised PLS-DA analysis.

23. A method according to claim 15, wherein said cluster represents patterns sharing a value for a phenotypic parameter of interest.

24. Method according to claim 15, wherein said at least two different sources for the plurality of array nucleic acid molecules are (taxonomically) closely related to the source of the sample nucleic acid.

25. Method according to claim 2, wherein:
at least one of said at least two different sources of said plurality of array nucleic acid molecules is also a source of at least one of said at least two different reference nucleic acids;
the average size of the molecules in said array is between about 200 to 5000 nucleotides;
the array comprises between about 1.500 and 5.000 nucleic acid molecules randomly chosen from said at least two different sources;
said plurality of array nucleic acid molecules is derived from natural sources, more preferably of viral, microbial, animal or plant origin, even more preferably a prokaryotic origin;
said at least two different sources for said plurality of array nucleic acid molecules are (taxonomically) closely related;
said plurality of array nucleic acid molecules is derived from at least two different species of prokaryotes;
said plurality of array nucleic acid molecules is derived from at least two different prokaryotic strains that belong to the same genus;
said plurality of array nucleic acid molecules is derived from at least two different prokaryotic strains that belong to the same species;
said plurality of array nucleic acid molecules is derived from a pure culture of a prokaryote;
said plurality of array nucleic acid molecules is derived from eukaryotic DNA;
said plurality of array nucleic acid molecules is derived from at least three, preferably at least 5, and even more preferably at least 8 different sources; and
wherein said method further comprises clustering representations of patterns based on Principal Component Analysis (PCA).

26. A method for typing sample nucleic acid, comprising:
providing at least two different clusters of reference hybridization patterns for a sample nucleic acid by using a method according to claim 25;
hybridizing the same array as used for preparing the reference hybridization patterns with sample nucleic acid to obtain a sample hybridization pattern, and
assigning the sample hybridization pattern to one of said at least two different clusters of reference hybridization patterns.

27. Method according to claim 26, wherein:
said sample nucleic acid consists of genomic DNA, more preferably of genomic DNA fragments;
the average size of the fragments in said sample nucleic acid is between about 50 to 5000 nucleotides;
said method comprises comparing the sample hybridization pattern with clusters of reference hybridization patterns comprising at least 3, more preferably at least 5 and even more preferably at least 50 different reference hybridization patterns;
said comparison comprises unsupervised multivariate analysis of the reference hybridization patterns together with the sample hybridization pattern;
said method further comprises clustering representations of patterns based on Principal Component Analysis (PCA).

28. Method according to claim 27, wherein:
said assigning comprises Partial Least Square-Discriminant Analysis (PLS-DA) of the reference hybridization patterns together with the sample hybridization pattern and wherein at least one phenotypic parameter of which the values are known for the reference hybridization patterns, (and which information is used to supervise the PLS-DA analysis), is additionally determined or estimated for the sample nucleic acid or the source it is derived from;
said method further comprises clustering representations of patterns based on the supervised PLS-DA analysis;
said cluster represents patterns sharing a value for a phenotypic parameter of interest;
said at least two different sources for the plurality of array nucleic acid molecules are (taxonomically) closely related to the source of the sample nucleic acid.
